(19) United States
(12) Patent Application Publication
(10) Pub. No.: US 2009/0218246 A1
(43) Pub. Date: Sep. 3, 2009

(54) Novelty device for identifying luggage and method of manufacture

(76) Inventor: Kimberly A. Weidler, Barrington, IL (US)

Correspondence Address: Meroni & Meroni, P.C., P.O.Box 309, Barrington, IL, 60011, US

(21) Appl. No.: 12/074,017

(22) Filed: Feb. 28, 2008

(51) Int. Cl. A45C 13/42; B23P 11/00

(52) U.S. Cl. 206/457; 190/102; 29/428

(57) ABSTRACT

A novelty device is linked to a piece of luggage for identifying and adorning the luggage. The novelty device comprises an axial, elongate torso-like structure comprising a series of fabric panels. Deep to the panels is certain fill material for providing elastically compressive bulk to the novelty device. Ventro-laterally extending linking panels extend from the ventral medial axis of the torso-like structure, the terminal ends of which comprise cooperable or matable fasteners. When the linking panel terminal ends are selectively fastened to one another via the fasteners after having been wrapped around an axial luggage handle or similar other luggage appendage, the linking panels function to attach the torso-like structure to the piece of luggage. Once attached to the luggage, the novelty device readily identifies the luggage. Certain methods for the manufacture of the novelty device are further disclosed.

### BACKGROUND OF THE INVENTION

1. Field of the Invention

The present invention generally relates to a novelty device for identifying luggage, and more particularly, to a novelty device of unique construction which removably affixes to a luggage handle or similar other axial luggage appendage so as to provide an amusing visual adornment to passersby, and to provide the owner with immediate identification of his or her personal luggage.

2. Description of the Prior Art

Weary travelers at baggage carousels at terminals are perhaps experts on the benefits of luggage identifying means. The more readily identifiable one's luggage, or the more readily one's luggage may be set apart from other luggage, is of a benefit to the traveler not only in terms of enhancing travel efficiency, but often also in terms of luggage adornment. Luggage, it may be noted, is often ornately adorned or decorated so as to set itself apart from other luggage that may be of a more mundane character. Further, fanciful creatures and the like may be employed to have utilitarian function other than mere amusement. Some of the prior art concerned with luggage identification and/or utilitarian creatures and the like, is briefly described hereinafter.

U.S. Pat. No. 1,277,785 ('785 patent), which issued to Urband, discloses a Traveling Bag. The '785 patent teaches a combination bag and flexible identification tab. The tab is secured at one end of the bag to one of certain separably connected members of the bag. Further, a flexible cover is secured at one end thereof to another member of the bag. Certain means to secure the identification tab and its cover are further disclosed and function to serve as handles to pull the bag-members apart.

U.S. Pat. No. 2,274,605 ('605 patent), which issued to Hoffmeister, discloses a Gripping Pad for Handles. The '605 patent teaches a hand grip pad for handles comprising a flat yieldable pad cover adapted for folding along its medial line for enclosing the handle between the posts of the handle and with the free edges of the cover positioned on top of the handle, a fastening device at the free edges of the cover for securing the same in position on the handle, a pair of resilient lining members secured to the inner surface of the cover with one edge of each member positioned in spaced parallel relation to each other at the fold line of the cover, said lining members being adapted to extend along the side of the handle and partly under the handle and notches at the end portions of the cover adapted for receiving the post of the handle, the ends of the cover at each side of the notches engaging opposite sides of the post to secure the pad in position against turning movement on the handle.

U.S. Pat. No. 2,712,336 ('336 patent), which issued to Casselman, discloses a Carrying Case. The '336 patent teaches a carrying case comprising a front wall, a rear wall, a base, a cover, a first pair of strap guide members fixedly secured to one of said front and rear walls, to the other of said front and rear walls, and an endless carrying strap, said strap being slidably engaged by at least said first and second pairs of guide members.

U.S. Pat. No. 4,901,462 ('462 patent), which issued to Wrigley, discloses a Luggage Tag. The '462 patent teaches a luggage tag formed from a soft hollow plastic body portion. The plastic may be treated with a photophorescent material so that the luggage tag will glow in the dark. The hollow plastic body portion has a central opening covered by a removable monogrammed cap. The cap covers a key shaped recess designed to hold a suitcase key. A resilient plastic circular loop clip is connected to the body portion for attaching the luggage tag to an article of luggage. In a second embodiment, the body portion is formed from open mesh plastic through which yarn is woven. The body portions may be formed as a variety of shapes including a teddy bear, a flower, a human foot, and any letter of the alphabet.

U.S. Pat. No. 5,059,149 ('149 patent), which issued to Stone, discloses a Stuffed Animal with Book Enclosure Apparatus. The '149 patent describes a stuffed animal apparatus comprising one or more storage compartments in which visual and/or audio materials may be stored and/or displayed. The storage compartments are disposed in the stuffed animal body or in an appendage. An external storage compartment is shown secured to an appendage. The storage compartments may need flap coverings or they may be a pouch and they may be large or small, as desired.

U.S. Pat. No. 5,178,574 ('574 patent), which issued to Evoy, discloses an Article having a Movable Fold Member for Alteration of a Feature. The '574 patent describes an article, such as a stuffed toy, has one or more folds of material on the surface, adjacent to a feature or features, the folds being movable to alternate positions to vary the appearance of a feature. As an example, for an animal, a fold can be positioned across the head above the eyes. In an up position the eyes are fully exposed, and in a down position, partially obscured. A further fold can be positioned across the head below the nose, in a down position covering the teeth and in an up position exposing the teeth.

U.S. Pat. No. 5,326,300 ('300 patent), which issued to Sonders, discloses a Combination Carrying Device and Toy. The '300 patent describes a combination carrying device and toy including a body having an exterior surface defining a toy-like structure and having interior surfaces defining at least one hollow body cavity being sufficiently sized to contain and carry desired baby accessories. At least one entry panel forms a portion of the exterior surface, the entry panel providing access to the hollow body cavity. The entry panel is fastened in a desired orientation relative to the exterior surface. Preferably, the body is in the shape of an ostensibly stuffed animal, such as a bear.

U.S. Pat. No. 5,344,356 ('356 patent), which issued to Pizzelli et al., discloses a Decorative Toy and Storage Unit with Attachable Holders. The '356 patent describes a toy with Velcro brand fastening means covering the visible surface, and holders also with Velcro brand fastening means. The holders are arranged as receptacles for small items, such as hair bows, combs and barrettes, and the holders may be attached to the toy in decorative, playful and creative ways providing a combination toy and decorative storage facility. The toy is preferably a stuffed animal.

U.S. Pat. No. 5,813,584 ('584 patent), which issued to Mauser, discloses a Stuffed Toy Carrier. The '584 patent describes a stuffed toy carrier for attachment to a strap or the like object by use of a reusable hook and pile fastener. The carrier allows for securement of a stuffed toy as well as ease of accessibility to the toy. The carrier forms a pocket-like structure having a top opening constricted by an elastic band formed integral to the upper rim and a first and second aperture for positioning the legs of the stuffed toy.

U.S. Pat. No. 6,030,085 ('085 patent), which issued to Leam et al., discloses an Adjustable Mirror Support Assembly. The '085 patent describes an adjustable stuffed animal mirror support assembly is provided to facilitate viewing of a rear facing infant in the back seat of an automobile. The stuffed animal's body carries a convex mirror. A support strap is connected to the rear side of the body and extends upwardly to the back side of the head. An anchor strap connects to the back of the head and is also connected to a weighted bag. The mirror is adjusted by adjusting the weighted bag on the rear deck of the automobile and by manipulating the support strap relative to the anchor strap, each of which carries a strip of Velcro.

U.S. Pat. No. 6,255,553 ('553 patent), and U.S. Pat. No. 6,586,651 ('651 patent), which issued to Sullivan, disclose certain adhesive bandages having at least one soft three-dimensional figure. In one form, a soft three-dimensional figure, such as a stuffed character, animal or object, is attached to the top surface of a flexible backing that is coated with adhesive on its skin-contacting, bottom surface and an absorbent pad is attached to the bottom surface and central portion of the flexible backing for application directly to a body wound. In another form, the figure could cover the wound directly, using either soft three-dimensional appendages coated with adhesive or appendages made of flexible backing material coated with adhesive to attach the bandage to the skin. The bandage could also be designed so that the figure could be easily removed from the rest of the bandage components to allow for play with the figure away from the wound site.

U.S. Pat. No. 6,364,365 ('365 patent), which issued to Caplan, discloses a Personal Luggage Identification System and Methods for Use. The '365 patent teaches a new adaptable luggage identification system and methods for its use. The system includes luggage recognition devices including adhesive stickers, tape, firm plastic tags, flexible plastic labels, business card carriers, tags, envelopes and cards, each bearing its own distinctive pattern, which can be affixed to luggage either singularly or in combination to provide a distinctive pattern or combination of patterns. The luggage recognition devices can be used to aid in the rapid identification of individual pieces of luggage, groups of luggage, contents of luggage or any combination thereof.

U.S. Pat. No. 6,401,889, ('889 patent), which issued to McCleskey, discloses a Luggage Lock Covering Device. The '889 patent teaches a luggage lock covering device for protecting a luggage lock from damage as well as protecting the luggage from damage caused by-the luggage lock. The luggage lock covering device includes a panel having a plurality of fold indentations therein such that a first portion, a second portion and a third portion are defined. The second portion is positioned between the first and third portions. The second portion includes an elongated slot extending therethrough. The elongated slot includes a size designed for removably receiving the luggage zipper. There is a fastening means for removably coupling the first portion to the third portion. The fastening means comprises a hook and loop fastening means that includes a loop portion and a hook portion.

U.S. Pat. No. 6,554,033 ('033 patent), which issued to Hydon, discloses a Luggage Handle Cover with ID Tag. The '033 patent teaches a luggage handle cover having a body portion with a first end, a second end, an inner side, and an outer side. The body portion has a length and width sufficient to substantially cover a luggage handle. The luggage handle cover also has a fastening mechanism coupled to the body portion to fasten the first end and the second end and an identification display disposed on the inner side of the body portion when the body portion is arranged to substantially cover a luggage handle.

United States Patent Application Publication No. US 2003/0135954, which was authored by Beckwith, teaches a universally fitting, removable padded wraparound luggage handle cover includes a substantially square and planar interior sheet of a cushioning, preferably foam-like material. About the cushioning material is peripherally secured a top and a bottom sheet of a flexible high woven fabric. To the top sheet of the fabric is secured an elongate strip of hook-and-loop material having a width in a range of about 1 to about 3.5 centimeters and secured to the top sheet along one entire edge thereof. A second or bottom strip of hook-and-loop material, generally complemental in width to the top strip, is secured to the bottom sheet of fabric along an edge opposite to the edge at which the top strip, is secured and in which the respective fabric edges define a distance therebetween in a range of about 12 to about 17 centimeters. The bottom sheet of fabric is preferably provided with a transparent envelope having one free edge into which may be inserted owner identification or other information. The thickness of the inventive removable wraparound handle cover is at its maximum when the hook-and-loop strips are secured to each other so that the entire handle cover assumes the geometry of an annular solid ellipsoid. In such condition, the strip defines a maximum thickness of the structure of about one centimeter. The strips and cushioning define an elongate zone of maximum thickness of the inventive handle cover that may be readily positioned by the user to protect a part of the hand or fingers that is most susceptible to pain or fatigue.

United States Patent Application Publication No. US 2006/028959, which was authored by Comiskey, teaches a luggage identification system and method. In one aspect, the invention is a luggage identification system comprising: a piece of luggage having an anchor that forms an opening; an elongate piece of fabric having a hook assembly and a loop assembly attached thereto; the elongate piece of fabric extending through the opening of the anchor of the piece of luggage; the hook assembly engaging the loop assembly thereby forming a fabric loop around the anchor and securing the elongate piece of fabric to the anchor.

It may be seen from an inspection of the foregoing art, as well as from a consideration of the state of the art generally, that the prior art does not disclose a fanciful creature having a torso portion with handle or axial member-enveloping linking panels extending from the ventral portion thereof, which fanciful creature may be attached to luggage handles by way of the linking panels for both adorning and identifying luggage. The prior art thus perceives a need for such a construction and associated methodology as set forth in more detail hereinafter.

### SUMMARY OF THE INVENTION

Accordingly, it is an object of the present invention to provide a novelty device that may be uniquely attached to a luggage handle so that users thereof may readily identify their luggage, and passersby may be greeted with the amusing effect achieved by way of the luggage identifier. To achieve these and other readily apparent objectives, the novelty device according to the present invention comprises laterally opposed dorsal panels, laterally opposed ventral panels, laterally opposed linking panels, and fill material. The dorsal panels extend ventro-laterally and laterally terminate at dorsal panel terminal edges. The ventral panels are ventrally attached to one another along a ventral, medial junction and extend dorso-laterally therefrom. The ventral panels laterally terminate at ventral panel terminal edges.

The respective dorsal and ventral panel terminal edges are attached to one another along left-right lateral junctions. The linking panels are ventrally attached to one another along the ventral, medial junction and extend ventro-laterally therefrom. The linking panels ventrally terminate at linking panel terminal portions. The linking panel terminal portions comprise certain fastening means for selectively fastening the linking panel terminal portions to one another.

The dorsal panels and ventral panels are together cooperably sized and shaped for effecting a torso structure. The linking panels are sized and shaped for encircling an axial appendage, such as a luggage handle. When the linking panel terminal portions are selectively fastened to one another via the fastening means after having been wrapped around the axial luggage handle or similar other luggage appendage, the linking panels function to attach the torso structure to the piece of luggage.

Other objects of the present invention, as well as particular features, elements, and advantages thereof, will be elucidated or become apparent from, the following description and the accompanying drawing figures.

### BRIEF DESCRIPTION OF THE DRAWINGS

Other features of my invention will become more evident from a consideration of the following brief description of patent drawings:

FIG. 1 is a side elevational view of a luggage-identifying novelty device according to the present invention as juxtaposed above the handle of a fragmentary piece of luggage.

FIG. 2 is a ventral plan view of the novelty device otherwise depicted in FIG. 1 with ventrally extending linking panels in a handle-receiving open state.

FIG. 3 is a ventral plan view of the novelty device otherwise depicted in FIG. 1 with ventrally extending linking panels in a closed state showing hook and loop fastening material operating to fasten the linking panels to one another.

FIG. 3a is a fragmentary ventral plan view of a first alternative fastening means for fastening the linking panels to one another, namely, cooperable snap-like structures.

FIG. 3b is a fragmentary ventral plan view of a first alternative fastening means for fastening the linking panels to one another, namely, cooperable zipper structures.

FIG. 4 is an anterior end view of the novelty device according to the present invention as juxtaposed above the handle of a piece of luggage with the handle-encircling linking panels in a handle-receiving, open state.

FIG. 5 is an anterior end view of the novelty device according to the present invention as juxtaposed above the handle of a piece of luggage with the handle-encircling linking panels in a handle-linking, closed state, and the torso-like structure being grasped by a user's hand.

FIG. 6 is a depiction of three identical pieces of luggage juxtaposed adjacent one another; the center piece of luggage being adorned with a luggage-identifying novelty device according to the present invention.

FIG. 7 is a cross-sectional end view of a torso-like structure of the novelty device as attached to a luggage handle with fill material thereof in a relaxed state moments before being grasped by a user's hand.

FIG. 8 is a cross-sectional end view of a torso-like structure of the novelty device as attached to a luggage handle with fill material thereof in a compressed state during grasping action by a user's hand.

FIG. 9 is a cross-sectional end view of a torso-like structure of the novelty device as attached to a luggage handle with fill material thereof in a relaxed state as the torso-like structure is released by a user's hand.

FIG. 10 is a perspective type depiction of an empty torso-like structure in a relaxed state moments before being grasped by a user's hand, the handle-linking panels being in a handle-receiving, open state.

FIG. 11 is a plan view of a back or dorsal fabric panel used in the construction of the novelty device.

FIG. 12 is a plan view of a belly or ventral fabric panel used in the construction of the novelty device.

FIG. 13 is a plan view of a linking fabric panel used in the construction of the novelty device.

FIG. 14 is a depiction of a belly or ventral fabric panel being attached to a back or dorsal fabric panel.

FIG. 15 is a depiction of a linking fabric panel attached to a ventral fabric panel, which ventral fabric panel is attached to a dorsal fabric panel.

FIG. 16 is a plan type depiction of left and right dorsal fabric panels attached to one another along a dorsal medial junction.

FIG. 17 is a plan type depiction of a single, dorsal fabric panel having no dorsal medial junction.

FIG. 18 is a cross-sectional end view of the torso-like structure of the novelty device showing fill material, and four panel-attachment junctions, the inferior most of which operates to attach left and right linking panels outfitted with cooperable hook and loop type fastening material on the terminal edges thereof.

FIG. 18a is a fragmentary perspective type depiction of left and right linking panels attached to the torso-like structure at an inferior most junction, which panels are outfitted with alternative fastening means, namely, cooperable zipper-like structures.

FIG. 19 is first sequential end view depiction showing left and right dorsal fabric panels attached to one another along a dorsal medial junction.

FIG. 20 is a second sequential end view depiction showing left and right ventral fabric panels attached to the left and right dorsal fabric panels along left-right lateral junctions.

FIG. 21 is a third sequential end view depiction showing left and right linking fabric panels attached to the left and right ventral fabric panels along a common ventral, medial junction (substantially identical to FIG. 18).

FIG. 22 is a cross-sectional end view depiction of the torso-like structure of an alternative novelty device showing fill material, and a single panel-attachment junction, which junction operates to simultaneously (1) attach left and right linking panels, and (2) close the torso-like structure.

### DETAILED DESCRIPTION OF THE PREFERRED EMBODIMENT(S)

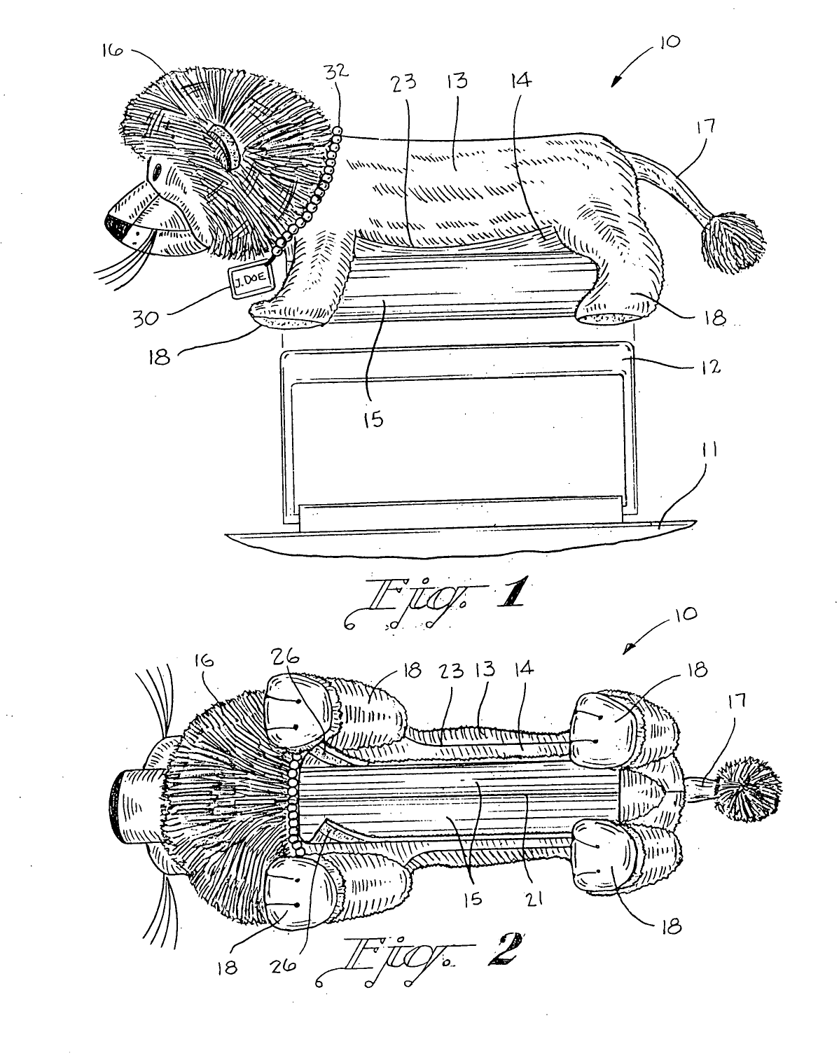

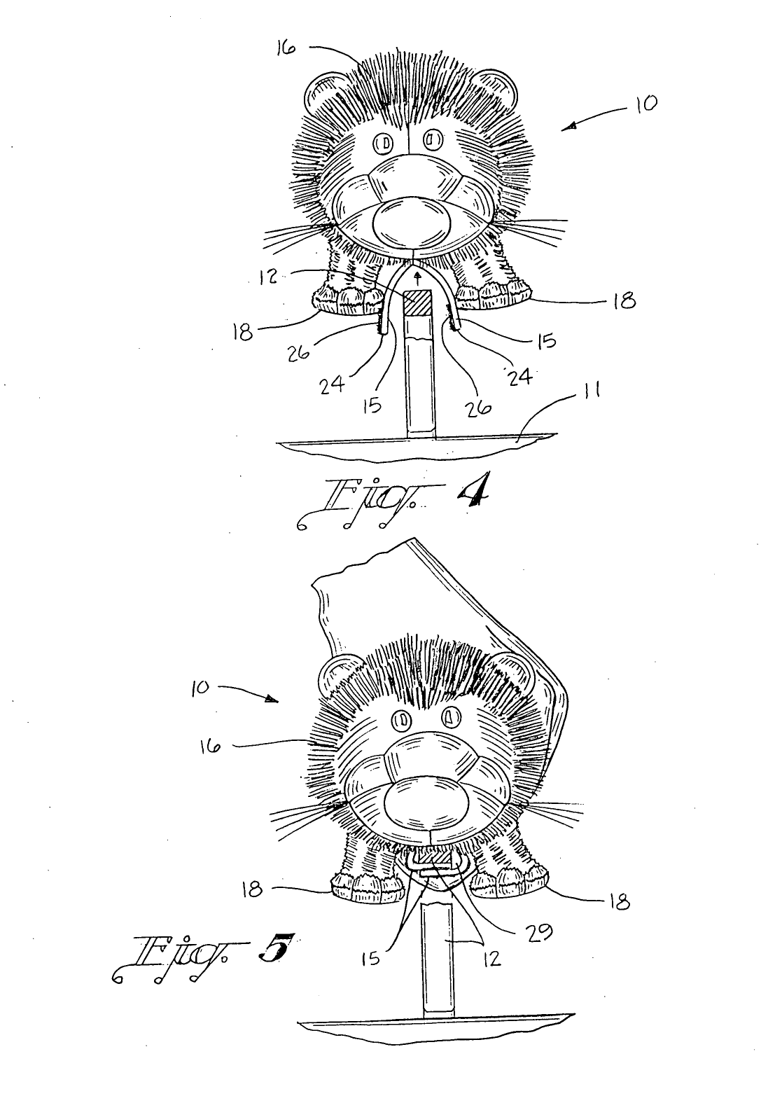

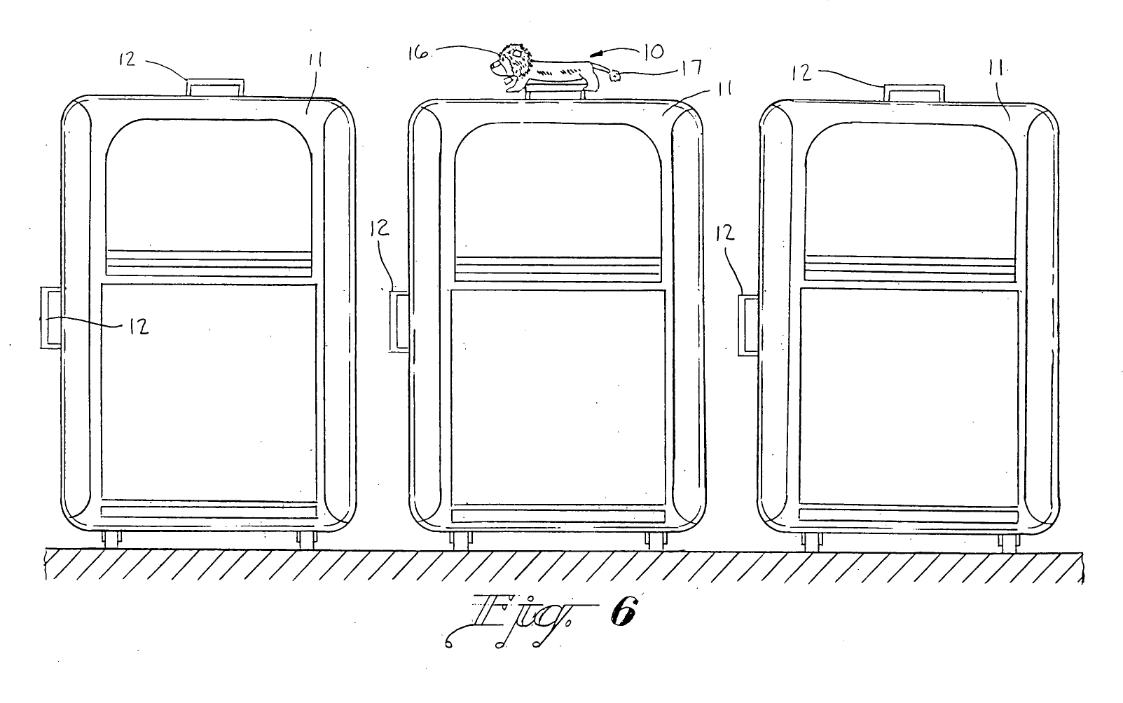

Referring now to the drawings with more specificity, the preferred embodiment of the present invention concerns a novelty device 10 for use in combination with a piece of luggage 11 so as to readily identify and/or adorn the luggage 11. The novelty device according to the present invention is generally illustrated and referenced in FIGS. 1-3, and 4-6. It is contemplated that the novelty device 10, as used in combination with a piece of luggage 11, may together be defined as a self-identifying luggage assembly. In may be understood from an inspection of FIGS. 1, and 4-9, that the piece of luggage 11 necessarily comprises at least one type of appendage having an axial portion, which may be preferably defined by a luggage handle 12.

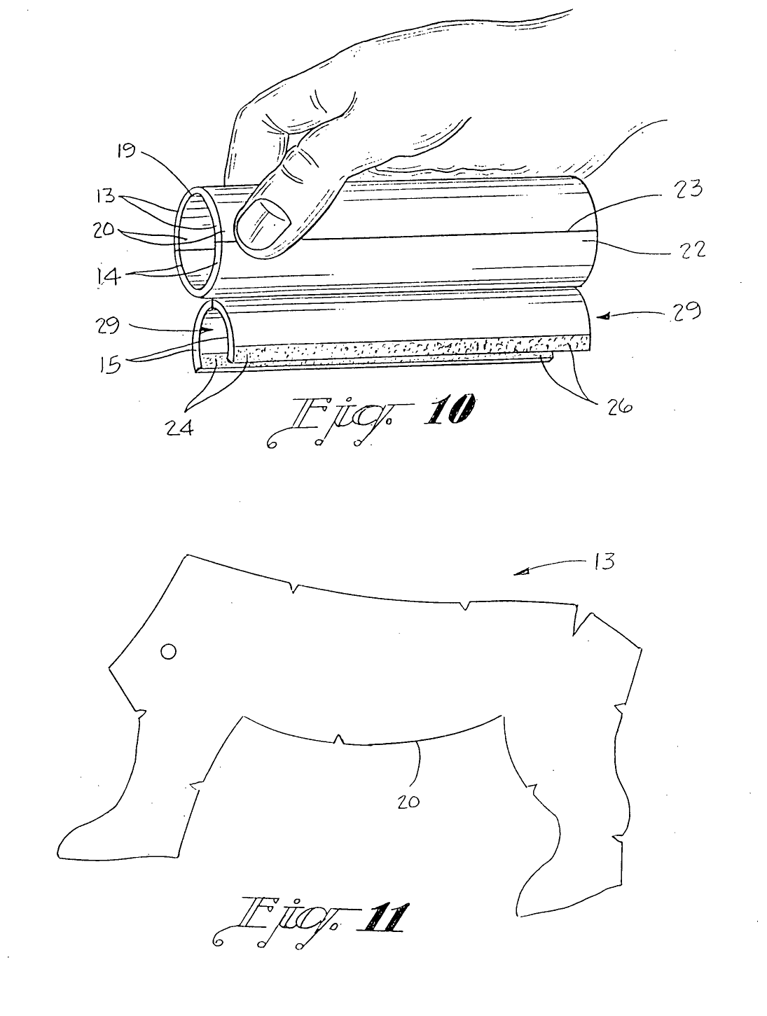

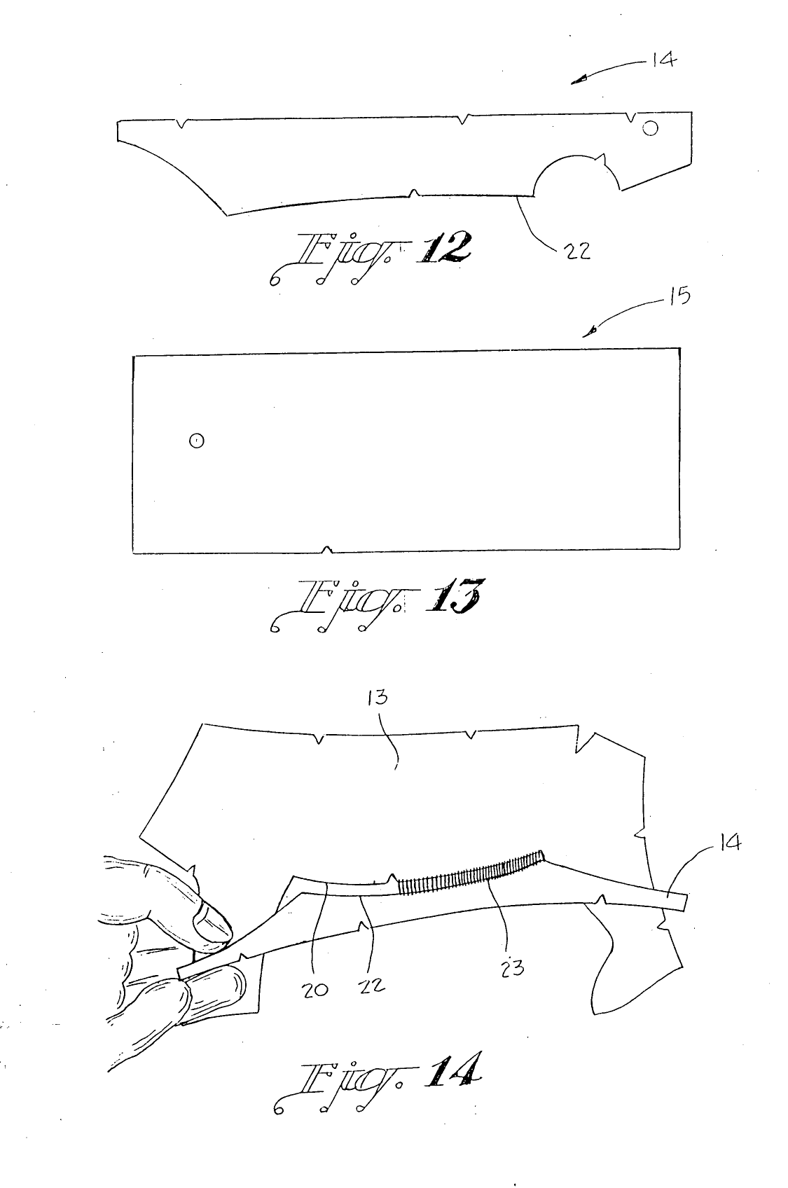

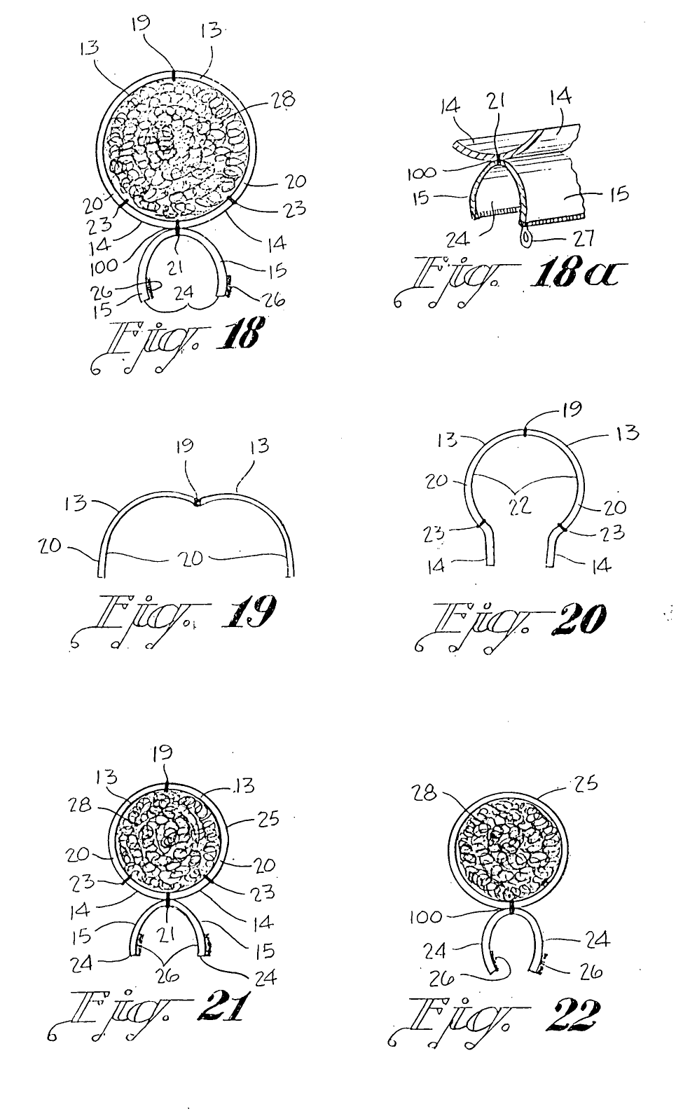

In its preferred construction, the novelty device 10 comprises a series of fabric panels, including dorsal panels, ventral panels, and linking panels. The dorsal panels 13 are preferably laterally opposed or comprise left and right dorsal panels as may be understood from an inspection of FIGS. 1-3b, 10, 11, 14, 15, 16, 18, 19, 20, and 21. A macro dorsal panel 31, being formed from a single piece of fabric material, is generally illustrated and referenced in FIG. 17. Similarly, left and right ventral panels 14 may preferably combine with the dorsal panels 13 to form a torso-like structure. Certain ventral panels 13 are referenced in FIGS. 1-3b, 10, 12, 14, 15, 18, 18a, 20, and 21. Certain of the linking panels 15 are illustrated and referenced in FIGS. 1-5, 10, 13, 15, 18, 18a, and 21.

It is further contemplated that certain anatomical features may be attached to the torso-like structure 25 so as to enhance the visual appeal, and luggage-identifying characteristics of the novelty device 10. In this regard, it is contemplated that these features may include an anterior anatomical structure such as a pronounced head 16, a posterior anatomical structure such as a tail 17, and a plurality of appendages or legs 18 (such as may be found on a quadruped) comprising two left legs 18, anterior and posterior, and two right legs 18, anterior and posterior.

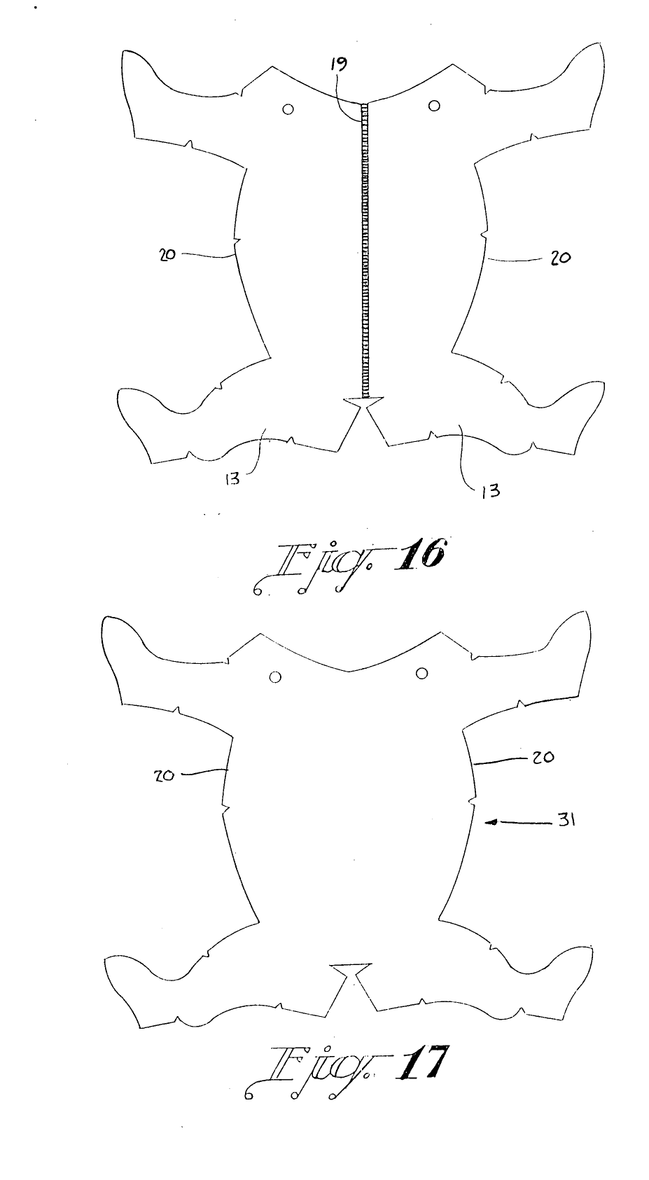

It may be readily understood from a consideration of the noted figures that the dorsal panels 13 are preferably dorsally attached to one another along a dorsal, medial junction 19 as specifically referenced in FIGS. 10, 16, 18, and 19-21. The dorsal panels 13 extend ventro-laterally and laterally terminate at dorsal panel terminal edges 20 as specifically referenced in FIGS. 10, 11, 14-18, 19, 20, and 21. The ventral panels 14 are ventrally attached to one another along a ventral, medial junction 21 as specifically referenced in FIGS. 18, 18a, and 21, and extend dorso-laterally therefrom, laterally terminating at ventral panel terminal edges 22. The respective dorsal and ventral panel terminal edges 20 and 22 are attached to one another along left-right lateral junctions 23.

The linking panels 15 are ventrally attached to one another along the ventral, medial junction 21 and extend ventro-laterally therefrom as generally depicted in the noted figures. Preferably, the ventral and linking panels 14 and 15 are attached to one another at the ventral medial junction 21 along a common fastening axis. The linking panels 15 ventrally terminate at linking panel terminal portions 24, which linking panel terminal portions 24 preferably comprise certain fastening means for selectively fastening the linking panel terminal portions 24 to one another.

The dorsal and ventral panels being sized and shaped for providing or defining a visually perceptible torso region or torso-like structure 25, and the linking panels 15 are sized and shaped for encircling the axial luggage handle 12 or similar other luggage appendage. The linking panel terminal portions 24 are selectively fastened to one another via the fastening means for attaching the torso region or structure 25 to the piece of luggage 11 via the handle 12 for adorning and identifying the piece of luggage according to the objectives of the present invention.

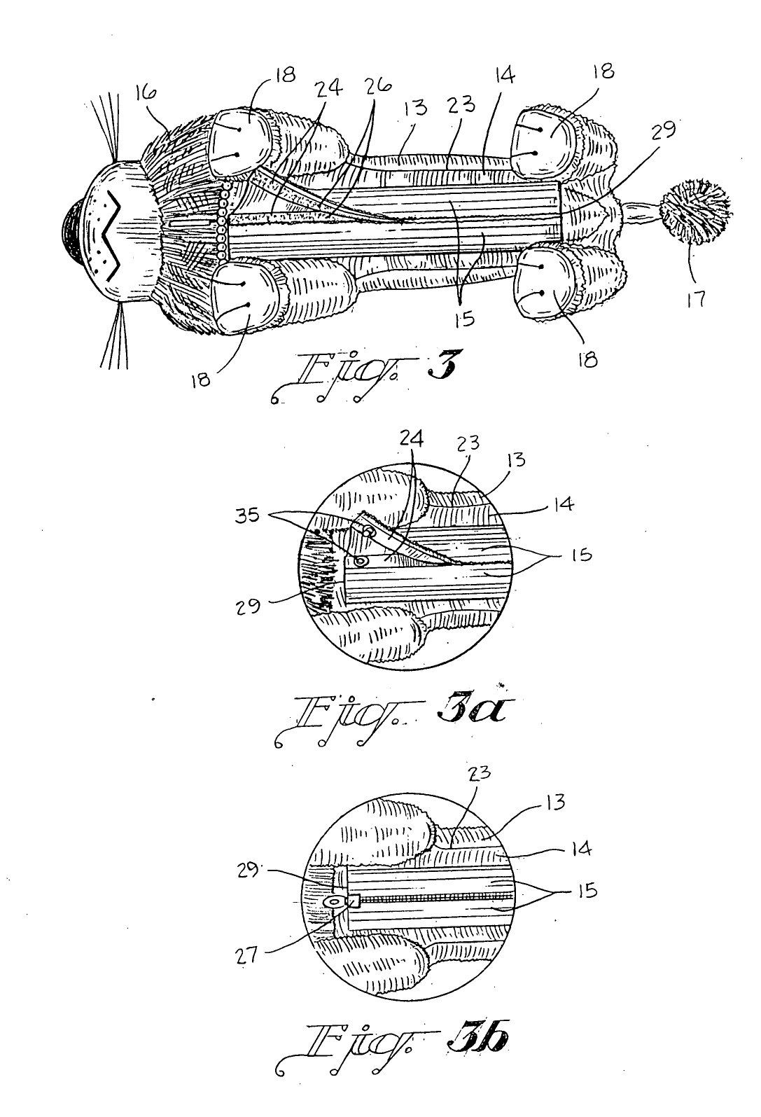

The fastening means attached to the linking panel terminal portions 24 may be preferably defined by Velcro brand hook and loop fastening material 26 as generally depicted and referenced in FIGS. 2, 3, 4, 10, 15, 18, 21, and 22. Alternatively, it is contemplated that the fastening means may be defined by zipper structures 27 as generally depicted and referenced in FIGS. 3b and 18a, or snap-like structures 35 as generically depicted in FIG. 3a.

Further, buckles, buttons, or other similar fabric material type fasteners could conceivably be utilized to selectively fasten the linking panel terminal portions 24 to one another. In any event, it is contemplated that the fastening means comprise a tensile strength sufficient to define the torso region or torso-like structure 25 as a pseudo luggage handle. In other words, when one grasps the axial torso-like structure 25, the same may well function as a second handle to the piece of luggage 11. Further, it is contemplated that all means for attaching the panels to one another may be defined by state of the art stitching and state of the stitching techniques.

The novelty device 10 may further preferably comprise fill material 28 deeply located relative to the dorsal and ventral panels 13 and 14 as generally depicted and referenced in FIGS. 7-9, 18, 20, and 21. Together, the dorsal and ventral panels 13 and 14 with deeply located fill material 28 are preferably sized and shaped for providing a manually graspable (i.e. hand graspable) torso region or torso-like structure 25.

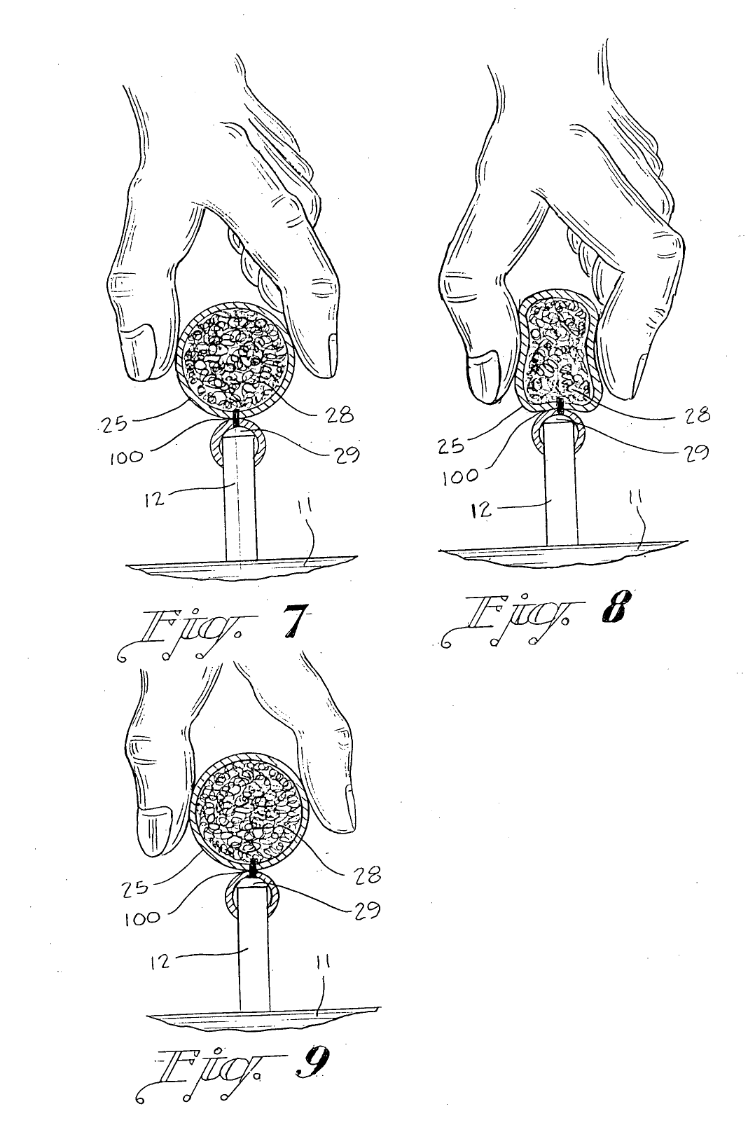

The fill material 28 preferably comprises polyester fiber and thus inherently has certain elastic properties. The elastic properties of the fill material 28 function to enable (1) torso compression when the torso-like structure 25 is manually grasped and/or compressed as generally depicted in FIG. 8, and (2) instantaneous torso relaxation (or return to a relaxed torso configuration) when compressive forces are removed or absent from the torso-like structure 25 as generally depicted in FIGS. 7 and 9.

As earlier specified, the novelty device 10 preferably comprises visually distinguishable anterior and posterior anatomical structures, such as an anterior head 16 and a posterior tail 17. The inclusion of such anatomical features or features that define the anterior end from the posterior end of the torso-like structure function to enhance the self identifying characteristics of the novelty device 10.

Notably, the linking panels 15, when encircled about the handle 12 or axial luggage appendage have axially opposite anterior and posterior openings as at 29 in FIGS. 3-3b, 5, and 7-10. In this last regard, it is contemplated that the distally extending appendages or legs 18 may well function to conceal the anterior and posterior openings 29 from extreme lateral perspectives as may be understood from a comparative inspection of the noted Figures.

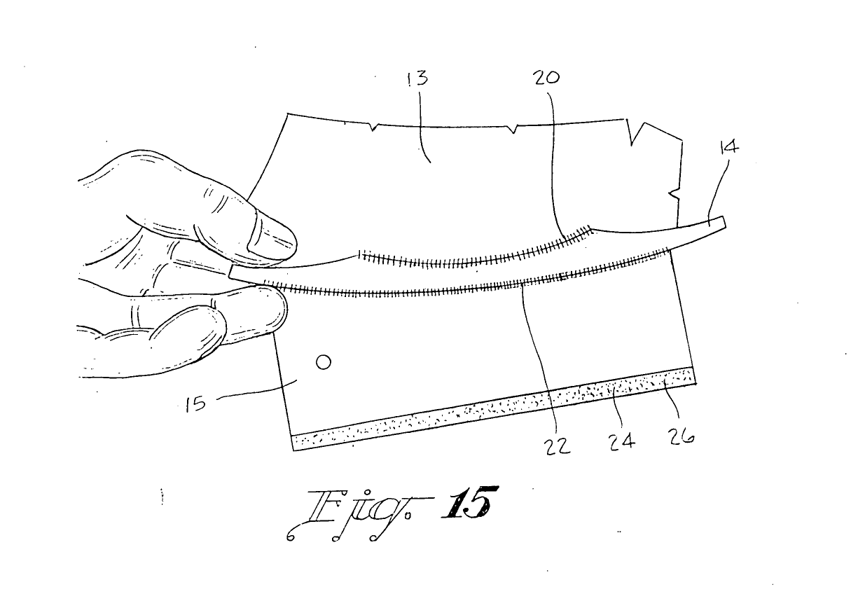

The unique construction of the novelty device 10 is believed to support certain new methodology for manufacturing and attaching a novelty device to luggage for identifying the same. In this regard, it is contemplated that the manufacture methodology of the novelty device may be said to comprise the steps of attaching laterally opposed dorsal panel structures (such as panels 13) to one another as generally depicted in FIG. 16. It is contemplated that this step may be eliminated by providing a single dorsal panel structure as at 31, to which may be attached laterally opposed ventral panel structures (such as panels 14).

After attaching the ventral panel structures to the dorsal panel structure, ventrally extending linking panel structures may be attached to the ventral panels along a common axis as at 100. This step operates to simultaneously form or close the torso like structure 25 and provide linking panel structures (such as panels 15) for encircling the same about a luggage handle or similar other structure. Once attached per the foregoing specifications, the torso-like structure 25 may well operate to identify the underlying piece of luggage 11.

The visually distinguishable anterior and posterior anatomical structures, such as the head 16 and tail 17 may be attached to the torso portion or torso-like structure 25 for enabling a user to visually distinguish anterior and posterior ends of the torso portion 25. Referencing FIG. 1, it may be seen that an identifying name tag 30 may be outfitted upon the anterior and/or posterior anatomical features.

In FIG. 1, the name tag 30 is attached to a head 16 via a necklace type or chain-like structure 32. Further, the space deep to the ventral and dorsal panel structures may be filled with fill material 28 before attaching the anterior and posterior structures to the torso portion 25. It is contemplated that the step of attaching the anterior and posterior structures may also operate to finally enclose the fill material 28.

While the above description contains much specificity, this specificity should not be construed as limitations on the scope of the invention, but rather as an exemplification of the invention. For example, as is described hereinabove, it is contemplated that the present invention essentially discloses a novelty device 10 for use in combination with luggage for adorning and identifying the luggage. The novelty device 10 of the present invention is believed to essentially comprise at least one dorsal panel, laterally opposed ventral panels, and laterally opposed linking panels.

The dorsal panel structure extends ventro-laterally and laterally terminates at dorsal panel terminal edges as may be referenced at 20. The ventral panels are laterally attached to the dorsal panel terminal edges along left-right lateral junctions as referenced at 23 and extend ventro-medially. The linking panels and ventral panels are ventrally attached to another along a ventral, medial junction as referenced at 21.

The linking panels extend ventro-laterally therefrom and ventrally terminate at linking panel terminal portions as referenced at 24. The ventral panel terminal edges 24 comprise certain fastening means for selectively fastening the linking panel terminal portions 24 to one another. Notably, the linking panels are preferably sized and shaped for encircling a luggage appendage and are selectively fastenable to one another via the fastening means for attaching the dorsal and ventral panels to luggage for adorning and identifying the same.

Stated another way, the novelty device may be used in combination with luggage for adorning and identifying the luggage, and essentially comprises an axial torso or torso-like structure, and laterally extending linking panels. The torso-like structure has a dorsal portion and a ventral portion, and the linking panels are ventrally attached to a select portion selected from the group consisting of the ventral and dorsal portions. The linking panels extend laterally from a medial axis, and terminate at linking panel terminal portions.

The linking panel terminal portions comprise certain fastening means for selectively fastening the linking panel terminal portions to one another. The linking panels are sized and shaped for encircling a luggage handle or similar other luggage feature, and are selectively fastenable to one another via the fastening means for attaching the torso-like structure to the luggage for adorning and identifying the same.

The method may be said to essentially comprise the steps of attaching laterally opposed ventral panel structures to a dorsal panel structure; attaching ventrally extending linking panel structures and the ventral panels to one another along a common axis, thereby forming a novel torso structure; and fastening the linking panel structures about a luggage portion, at which time the torso structure may well function to identify the underlying luggage. Stated another way, the method may be said to essentially comprise the steps of attaching a laterally extending linking panel structure to a torso-like structure along a medial axis; and fastening the laterally extending linking panel structure about a luggage portion, the torso-like structure thereby identifying underlying luggage.

Although the invention has been described by reference to several preferred embodiments and certain methodology, it is not intended that the construction of the novelty device or apparatus and method of manufacturing and attaching the same be limited thereby, but that modifications thereof are intended to be included as falling within the broad scope and spirit of the foregoing disclosure and the appended drawings.

I claim:

1. A combination luggage assembly for easing luggage identification, the luggage assembly comprising, in combination:
a piece of luggage, the piece of luggage comprising an axial appendage; and
a novelty device, the novelty device comprising a dorsal panel, laterally opposed ventral panels, and laterally opposed linking panels, the dorsal panel extending ventro-laterally and laterally terminating at dorsal panel terminal edges, the ventral panels being ventrally attached to one another along a ventral, medial junction and extending dorso-laterally therefrom, the ventral panels laterally terminating at ventral panel terminal edges, the respective dorsal and ventral panel terminal edges being attached to one another along left-right lateral junctions, the linking panels being ventrally attached to one another along the ventral, medial junction and extending ventro-laterally therefrom, the linking panels ventrally terminating at linking panel terminal portions, the linking panel terminal portions comprising fastening means for selectively fastening the linking panel terminal portions to one another, the dorsal and ventral panels being sized and shaped for effecting a torso structure, the linking panels being sized and shaped for encircling the axial appendage, the linking panel terminal portions being selectively fastened to one another via the fastening means thereby attaching the torso portion to the piece of luggage via the axial appendage.

2. The combination of claim 1 wherein the novelty device comprises fill material deep to the dorsal and ventral panels, the dorsal and ventral panels with deeply located fill material being sized and shaped for providing a manually graspable torso region.

3. The combination of claim 2 wherein the fill material comprises elastic properties, the elastic properties for enabling torso compression when the torso portion is manually grasped and enabling torso relaxation when compressive forces are removed from the torso portion.

4. The combination of claim 3 wherein the fastening means effect a tensile strength sufficient to define the torso portion as a pseudo luggage appendage.

5. The combination of claim 1 wherein the ventral and linking panels are attached to one another at the ventral, medial junction along a common fastening axis.

6. The combination of claim 1 wherein the novelty device comprises visually distinguishable anterior and posterior structures, the linking panels thereby having axially opposite anterior and posterior openings, the anterior and posterior structures for enhancing luggage identification.

7. The combination of claim 6 comprising appendages, the appendages distally extending from the torso portion for concealing the anterior and posterior openings from extreme lateral perspectives.

8. A novelty device for use in combination with luggage, the novelty device for adorning and identifying the luggage, the novelty device comprising:
a dorsal panel structure, the dorsal panel structure extending ventro-laterally and laterally terminating at dorsal panel terminal edges;
laterally opposed ventral panels, the ventral panels being laterally attached to the dorsal panel terminal edges along left-right lateral junctions and extending ventro-medially; and
laterally opposed linking panels, the linking and ventral panels being ventrally attached to another along a ventral, medial junction, the linking panels extending ventro-laterally from the ventral, medial junction and ventrally terminating at linking panel terminal portions, the linking panel terminal portions comprising fastening means for selectively fastening the linking panel terminal portions to one another, the linking panels being sized and shaped for encircling a luggage appendage and being selectively fastenable to one another via the fastening means for attaching the dorsal and ventral panels to luggage for adorning and identifying the same.

9. The novelty device of claim 8 wherein dorsal panel structure comprises laterally opposed dorsal panel portions, the dorsal panel portions being attached to one another along a dorsal, medial junction.

10. The novelty device of claim 9 comprising fill material, the fill material filling space deep to the dorsal and ventral panels, the dorsal and ventral panels with deeply located fill material being sized and shaped for providing a manually graspable torso portion.

11. The novelty device of claim 10 wherein the fill material comprises elastic properties, the elastic properties for enabling torso compression during grasping action and torso relaxation during torso release.

12. The novelty device of claim 9 wherein the fastening means comprise a tensile strength sufficient to define the torso region as pseudo luggage handle.

13. The novelty device of claim 9 comprising visually distinguishable anterior and posterior structures, the linking panels thereby defining axially opposite anterior and posterior openings, the anterior and posterior structures thus for enhancing luggage adornment and identification.

14. The novelty device of claim 13 comprising appendages, the appendages distally extending from the torso portion for concealing the anterior and posterior openings from extreme lateral perspectives.

15. A novelty device for use in combination with luggage for identifying the same, the novelty device comprising:
a torso structure, the torso structure having a dorsal portion and a ventral portion; and
laterally opposed linking panels, the linking panels being attached to a select portion, the select portion being selected from the group consisting of the dorsal and ventral portion, the linking panels extending laterally from a medial axis thereof, the linking panels terminating at linking panel terminal portions, the linking panel terminal portions comprising fastening means for selectively fastening the linking panel terminal portions to one another, the linking panels being sized and shaped for encircling a luggage portion and being selectively fastenable to one another via the fastening means for attaching the torso structure to the luggage portion.

16. A method for manufacturing a novelty device to luggage for identifying the same, the method comprising the steps of:
attaching laterally opposed ventral panel structures to a dorsal panel structure; and
attaching ventrally extending linking panel structures and the ventral panels to one another along a common axis, thereby forming a torso structure.

17. The method of claim 16 comprising the steps of fastening the linking panel structures about a luggage portion after forming the torso structure, the torso structure thereby identifying underlying luggage.

18. The method of claim 16 wherein laterally opposed dorsal panels are dorsally attached to one another along a dorsal, medial junction to form the dorsal panel structure before attaching the ventral panel structures thereto.

19. The method of claim 16 wherein visually distinguishable anterior and posterior structures are attached to the torso structure, the anterior and posterior structures for enabling a user to visually distinguish anterior and posterior ends of the torso structure.

20. The method of claim 19 comprising the step of filling space deep to the ventral panels and dorsal panel structure with fill material before attaching the anterior and posterior structures to the torso structure, the step of attaching the anterior and posterior structures operating to enclose the fill material.

21. The method of claim 20 comprising the step of distally extending appendages from the torso structure for concealing anterior and posterior ends of the linking panel structures.

22. A method for manufacturing and attaching a novelty device to luggage for identifying the same, the method comprising the steps of:
attaching a laterally extending linking panel structure to a torso-like structure along a medial axis; and
fastening the laterally extending linking panel structure about a luggage portion, the torso-like structure thereby identifying underlying luggage.

23. The method of claim 22 wherein the laterally extending linking panel structure extends ventro-laterally relative to the torso-like structure.

24. The method of claim 22 wherein the step of attaching the laterally extending linking panel structure to the torso-like structure operates to simultaneously close the torso-like structure and provide laterally extending linking panels.
